(19) United States
(12) Patent Application Publication
(10) Pub. No.: US 2017/0279349 A1
(43) Pub. Date: Sep. 28, 2017

(54) HIGH EFFICIENCY CHARGE PUMP WITH AUXILIARY INPUT OPERATIVE TO OPTIMIZE CONVERSION RATIO

(71) Applicant: LINEAR TECHNOLOGY CORPORATION, Milpitas, CA (US)

(72) Inventors: Samuel H. NORK, Andover, MA (US); Edward L. HENDERSON, Ottawa (CA)

(21) Appl. No.: 15/432,621

(22) Filed: Feb. 14, 2017

Related U.S. Application Data
(60) Provisional application No. 62/312,889, filed on Mar. 24, 2016.

(51) Int. Cl. H02M 3/07

(52) U.S. Cl. CPC H02M 3/07

(57) ABSTRACT

Switched capacitor circuit architectures that may enable high efficiency step-up or step-down dc-dc conversion from a primary, fixed supply input voltage using a four-switch switched capacitor topology and a separate auxiliary supply input voltage. The auxiliary supply input voltage can be optimized within the system or chosen from among other readily available supplies in the system to achieve the highest efficiency conversion ratio, without modifying the switch and flying capacitor arrangement. The auxiliary supply input voltage may be applied to other fixed conversion ratio converters to achieve higher efficiency conversion.

### CROSS-REFERENCE TO RELATED APPLICATION

This application is based upon and claims priority to U.S. provisional patent application 62/312,889, entitled “HIGH EFFICIENCY CHARGE PUMP WITH AUXILIARY INPUT OPERATIVE TO OPTIMIZE CONVERSION RATIO,” filed Mar. 24, 2016, attorney number 081318-0992. The entire content of this application is incorporated herein by reference.

### BACKGROUND

Technical Field

This disclosure relates to switched capacitor voltage converters.

Description of Related Art

Switched capacitor voltage converters can be attractive because of their small size, simple application circuit, low noise, and/or lack of inductor. However, the maximum efficiency of a switched cap converter may be a function of the input voltage level VIN, the output voltage level VOUT, and the dc-dc conversion ratio N.

The dc-dc conversion ratio may be determined by the switch and flying capacitor arrangement of the converter and may be fixed. Variable, fractional, or extremely high (3× or more) conversion ratios can be very costly due to an increased number of switches and capacitors.

A first order equation for boost charge pump efficiency may be written as:

Max Eff=VOUT/(N*VIN)

where N is the boost conversion ratio.

FIG. 1 illustrates an example of a prior art switched capacitor voltage converter using a doubler charge pump. As illustrated in FIG. 1, the converter may have only four switches 101, 103, 105, and 107 and a flying capacitor 109.

Using a doubler charge pump to boost a 12V input to make a 15V output may have a best case power efficiency of only 62.5%.

Poor efficiency can be problematic, especially at higher voltages. Even modest output currents can result in significant power loss and heat generation.

FIG. 2 illustrates an example of a prior art switched capacitor voltage converter that may provide a fractional boost of 1.5×. As illustrated in FIG. 2, this converter may include switches 201, 203, 205, 209, 211, 215, and 217, and flying capacitors 207 and 213.

Using a fractional boost that converts in a 1.5× boost ratio may achieve 83.3% max efficiency while making a 15V output from a 12V input, but may require seven switches and two flying capacitors, as illustrated in FIG. 2. The increase in power efficiency may come with a big increase in cost (more switches) and an increase in circuit complexity (extra flying capacitor).

A solution that preserves the simplicity of a doubler charge pump, but provides higher conversion efficiency, may be desirable.

### SUMMARY

A charge-pump circuit may include: a capacitor having first and second capacitor terminals; a first switch coupled between the first capacitor terminal and a ground node; a second switch coupled between the second capacitor terminal and an auxiliary supply voltage input node; a third switch coupled between the first capacitor terminal and a primary supply voltage input node; and a fourth switch coupled between the second capacitor terminal and an output voltage node.

A charge-pump circuit may include: a capacitor having first and second capacitor terminals; a first switch coupled between the first capacitor terminal and an output voltage node; a second switch coupled between the second capacitor terminal and an auxiliary supply voltage input node; a third switch coupled between the first capacitor terminal and a primary supply voltage input node; and a fourth switch coupled between the second capacitor terminal and the output voltage node.

A method of operating a charge-pump circuit including a charge-pump capacitor may include: during a first clock phase, coupling the capacitor of the charge-pump circuit to an auxiliary voltage supply input; and during a second clock phase distinct from the first clock phase, coupling the charge-pump capacitor in series between a primary voltage supply input node and an output node of the charge-pump circuit, wherein the auxiliary voltage supply receives a supply voltage different from a voltage level at the auxiliary voltage supply input node of the charge-pump circuit.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of a prior art switched capacitor voltage converter using a doubler charge pump.

FIG. 2 illustrates an example of a prior art switched capacitor voltage converter that may provide a fractional boost.

FIG. 3 illustrates an example of a step-up switched capacitor voltage converter that provides improved efficiency using an auxiliary supply voltage input VAUX.

FIG. 4 illustrates an example of a step-down switched capacitor voltage converter that provides improved efficiency using an auxiliary supply voltage input VAUX.

FIG. 5 illustrates another example of a step-up switched capacitor voltage converter that provides improved efficiency using an auxiliary supply voltage input VAUX.

FIG. 6 illustrates another example of a step-up switched capacitor voltage converter that provides improved efficiency using an auxiliary supply voltage input VAUX.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

Switched capacitor circuit architectures are now presented which may enable high efficiency step-up or step-down dc-dc conversion from a primary, fixed supply input voltage using a four-switch switched capacitor topology and a separate auxiliary supply input voltage.

The auxiliary supply input voltage can be optimized within the system or chosen from among other readily available supplies in the system to achieve the highest efficiency conversion ratio, without modifying the switch and flying capacitor arrangement. The auxiliary supply input voltage may be applied to other fixed conversion ratio converters to achieve higher efficiency conversion.

The converters that are now discussed may make use of the fact that numerous high efficiency supplies are commonly available in modern systems. These may be generated from a common system input supply using high efficiency step-down regulators.

By using an auxiliary input supply VAUX (generated at high efficiency from the common system input supply), instead of just a single input supply, very high boost conversion efficiency may be possible using the same number of switches and capacitors (e.g., four switches and one flying capacitor), as with the simple doubler charge-pump, independent of the ratio VIN/VOUT. By allowing the VAUX input to have a wide voltage range of either greater than or less than VIN, a wide range of effective conversion ratios (and corresponding improvements in efficiency) may be possible with only a four switch, single flying capacitor boost or step-down charge pump topology.

FIG. 3 illustrates an example of a step-up switched capacitor voltage converter that provides improved efficiency using an auxiliary voltage input VAUX. As illustrated in FIG. 3, the converter may have a regular supply voltage input VIN, an auxiliary supply voltage input VAUX, switches 301, 303, 307, and 309, a flying capacitor 305, and an output voltage VOUT.

Each switch may be any type of manual or electronic switch. For example one or more of the switches may be a BJT, FET, or MOSFET.

The supply input voltages VIN and VAUX may be set so as to ensure that the sum of VIN and VAUX is greater than or equal to the desired output voltage VOUT. VAUX may be derived from a source separate from the VIN source or may be derived from the same VIN using a high efficiency DC-DC converter. “A” and “B” may refer to distinct clock phases which control the switching operation. Each switch marked with an “A” may be operated in unison according to a first timing scheme, while each switch marked with a “B” may be operated in unison according to a second timing scheme. The timing schemes may be set such that the “A” and “B” clock phases do not overlap. A controller (not shown) may be configured to provide these switching signals to the switches.

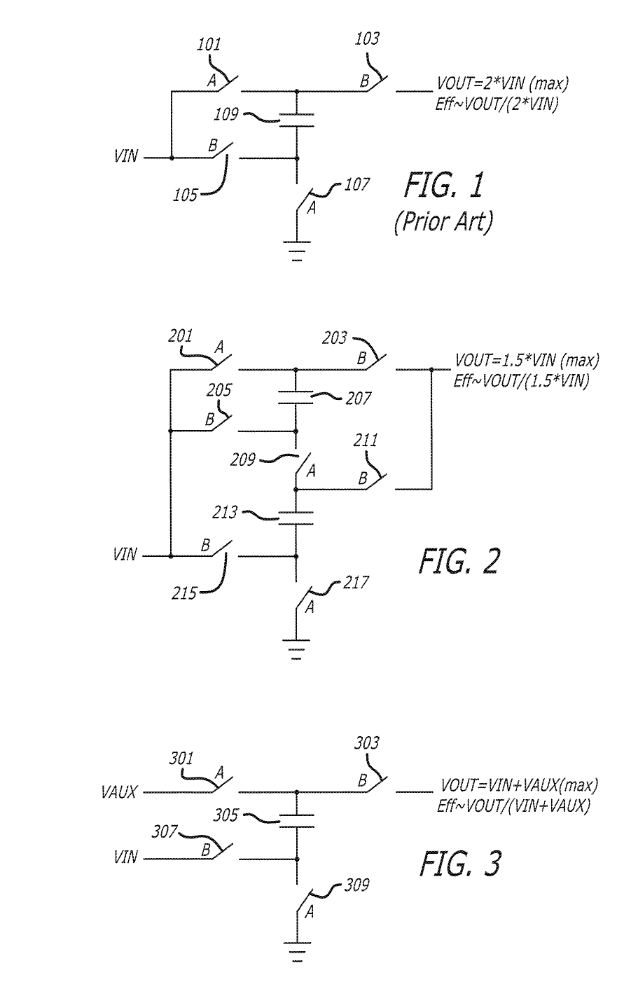

For example, if 5V is applied to VAUX supply and 12V is applied to VIN, a 15V boosted output can be generated with 88% maximum efficiency using the switch and capacitor arrangement shown in FIG. 3. This may constitute a 26% improvement in efficiency, as compared to the efficiency of a simple doubler, such as the one shown in FIG. 1.

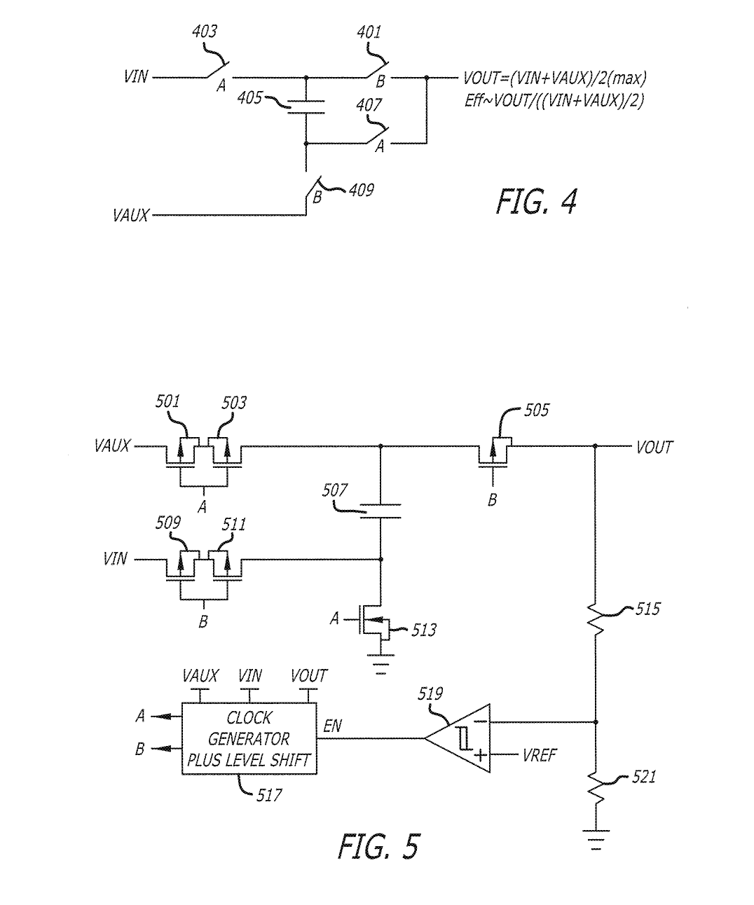

FIG. 4 illustrates an example of a step-down switched capacitor voltage converter that provides improved efficiency using an auxiliary voltage input VAUX. As illustrated in FIG. 4, the converter may include a regular supply voltage input VIN, an auxiliary supply voltage input VAUX, switching transistors 401, 403, 407, and 409, a flying capacitor 405, and an output voltage VOUT.

Each switch may be any type of manual or electronic switch. For example one or more of the switches may be a BJT, FET, or MOSFET.

The supply input voltages VIN and VAUX may be set so as to ensure that the expression (VIN+VAUX)/2 is greater than or equal to the desired output voltage VOUT. VAUX may be derived from a source separate from the VIN source or may be derived from the same VIN using a high efficiency DC-DC converter. “A” and “B” may refer to distinct clock phases which control the switching operation. Each switch marked with an “A” may be operated in unison according to a first timing scheme, while each switch marked with a “B” may be operated in unison according to a second timing scheme. The timing schemes may be set such that the “A” and “B” clock phases do not overlap. A controller (not shown) may be configured to provide these switching signals to the switches.

FIG. 5 illustrates another example of a step-up switched capacitor voltage converter that provides improved efficiency using an auxiliary voltage input VAUX. As illustrated in FIG. 5, the converter may include a regular voltage supply input VIN, an auxiliary supply input VAUX, switching transistors 501, 503, 505, 509, 511, and 513, a flying capacitor 507, resistors 515 and 521, a feedback regulator that may include a comparator 519 and a clock generator/pulse level shifter 517, and an output voltage VOUT. Each switch may be any type of manual or electronic switch. For example one or more of the switches may be a BJT, FET, or MOSFET.

As shown in FIG. 5, the charge pumps of FIGS. 3 and 4 may be used in conjunction with a feedback regulator control loop. The feedback regulator control loop may control the operation of the charge pumps based on the value of the output voltage at the VOUT node.

The comparator 519 may compare a reference voltage VREF to a scaled version of the output voltage VOUT. The results of this comparison may be used to control the clock generator/pulse level shifter 517. Specifically, the EN output signal from comparator 519 may enable or disable all switch clocking action inside clock generator/level shifter 517.

For example, in the example shown in FIG. 5, the feedback regulator control loop may control the enabling of clock phases “A” and “B” based on a determination of whether the output voltage exceeds or falls below a predetermined threshold VREF. When the clock generator/level shifter 517 is enabled by an EN signal from the comparator 519, the output voltage VOUT may increase. When the clock generator/level shifter 517 is disabled, an external load on VOUT may cause the output voltage VOUT to decrease.

In the example, the clock generator/level shifter 517 may be enabled when the output voltage falls below a threshold set according to VREF, and the clock generator circuit may be disabled when the output voltage exceeds the threshold set according to VREF. In this manner, the clock generator circuit may be enabled and disabled to maintain a specified output voltage.

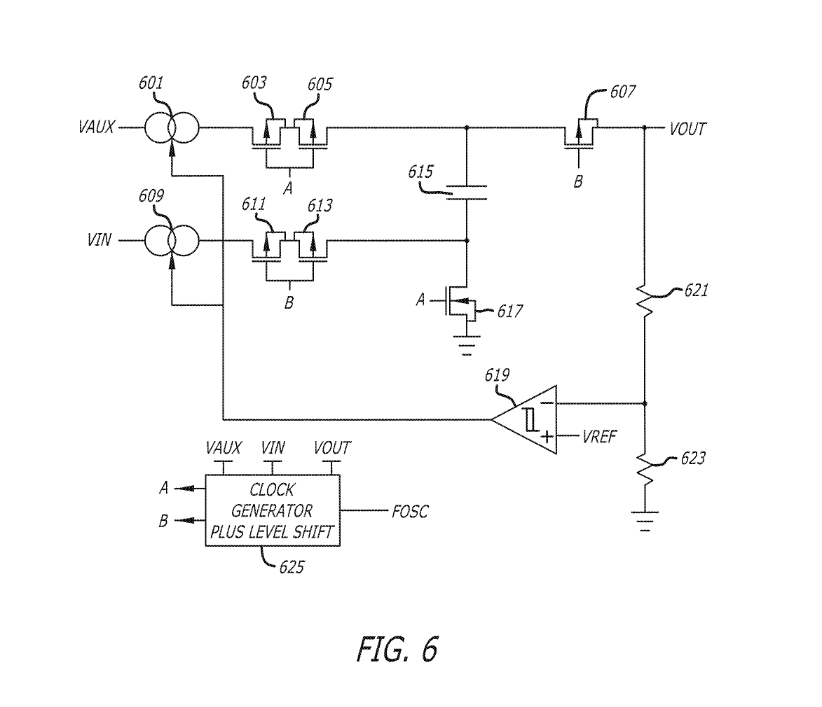

FIG. 6 illustrates another example of a step-up switched capacitor voltage converter that provides improved efficiency using an auxiliary supply voltage input VAUX.

As illustrated in FIG. 6, the converter may include a regular voltage supply input VIN, an auxiliary supply input VAUX, input current sources 601 and 609, switching transistors 603, 605, 607, 611, 613, and 617, a flying capacitor 615, resistors 621 and 623, a feedback regulator that may include a comparator 619 and a clock generator/pulse level shifter 625, and an output voltage VOUT. Each switch may be any type of manual or electronic switch. For example one or more of the switches may be a BJT, FET, MOSFET.

The clock generator/pulse level shifter may run continuously at a fixed frequency based on an fixed oscillator frequency input FOSC. The charge delivered to the flying capacitor 615 may be modulated via current sources at one or both supply inputs according to whether or not the output voltage is above or below a predetermined threshold VREF.

There are many other ways to produce regulated output voltages using switched capacitor dc-dc converters. Charge pump dc-dc converters may have some basic properties in common. They may use a multiphase clock (typically a 2 phase clock) for ON/OFF control of the switches in the switch array, and thereby control the charge transfer onto and off of the flying capacitor(s) which transfer(s) charge to the output. As a result, the power conversion efficiency may be determined by the physical laws of the switch and capacitor connections as indicated previously.

In general, a single input charge pump may need a very complex switch arrangement to achieve high efficiency under worst case conditions. However, in accordance with what has been described herein, straightforward charge pump switch and flying capacitor circuits (e.g., as shown in FIGS. 3-6) can be used to provide high efficiency at conversion ratios set in accordance with the voltage level VAUX.

The circuits presented herein may use an auxiliary input VAUX in lieu of a more complex switch and flying capacitor arrangement to achieve high efficiency regulated dc-dc conversion. The circuit topology can be adapted to provide a high efficiency boosted VIN tracking voltage over a widely varying VIN range using a fixed VAUX supply.

Unless otherwise stated, all measurements, values, ratings, positions, magnitudes, sizes, and other specifications that are set forth in this specification, including in the summary statements that follow, are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

In the foregoing Detailed Description, it can be seen that various features are grouped together in various embodiments for the purpose of streamlining the disclosure. This method of disclosure is not to be interpreted as reflecting an intention that the embodiments require more features than are expressly recited in each summary statement detailed below. Rather, as the following summary statements reflect, inventive subject matter lies in less than all features of a single disclosed embodiment. Thus the following summary statements are hereby incorporated into the Detailed Description, with each summary statement standing on its own as a separate subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended that any and all applications, modifications and variations fall within the true scope of the present disclosure.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and/or advantages. These also include embodiments in which the components and/or steps are arranged and/or ordered differently.

For example, a VAUX supply may be used together with a main VIN supply in a simple four switch inverting topology to generate an inverted −VOUT supply with higher efficiency than might otherwise be obtained with a single VIN input provided the VAUX supply could sink current.

What has been described may allow simple charge pump doubler and halfer topologies to be used in place of more complex fractional conversion topologies to achieve high efficiency step-up and step-down regulated output supplies. The inverting case just described may only be achievable under specific VAUX conditions. The “A” and “B” clock phases can be switched or run at different duty cycles and with different amounts of dead time when neither clock is “ON.” Similarly, other methods may be used for regulating the output voltage (in either boost, buck or inverting configurations) which may require clocks to stop, change duty cycle, or run continuously using alternate means, such as the current sources in FIG. 6. However, the regulation method may not improve efficiency.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A charge-pump circuit comprising:
a capacitor having first and second capacitor terminals;
a first switch coupled between the first capacitor terminal and a ground node;
a second switch coupled between the second capacitor terminal and an auxiliary supply voltage input node;
a third switch coupled between the first capacitor terminal and a primary supply voltage input node; and
a fourth switch coupled between the second capacitor terminal and an output voltage node.

2. The charge-pump circuit of claim 1 wherein:
the first and second switches operate in synchronization with each other; and
the third and fourth switches operate in synchronization with each other.

3. The charge-pump circuit of claim 1 wherein the auxiliary supply voltage input node has a configuration that receives an auxiliary supply voltage input different from the primary supply voltage input at the primary supply voltage input node.

4. The charge-pump circuit of claim 3 wherein the charge-pump circuit outputs at the output voltage node a step-up boosted version of the voltage at the primary supply voltage input node based on the voltage at the auxiliary supply voltage input node.

5. The charge-pump circuit of claim 1 wherein:
the first and second switches are closed during a first clock phase and open during a second clock phase;
the third and fourth switches are open during the first clock phase and closed during the second clock phase; and
the first and second clock phases are complementary clock phases.

6. The charge-pump circuit of claim 5 further comprising a feedback regulator controlling the first and second clock phases based on a voltage level at the output voltage node.

7. The charge-pump circuit of claim 6 wherein the feedback regulator comprises a clock generator circuit outputting a first clock signal for controlling the first and second switches and a second clock signal for controlling the third and fourth switches, wherein the clock generator circuit controls first and second clock phases of the first and second clock signals based on the voltage level at the output voltage node.

8. The charge-pump circuit of claim 7 wherein:
the clock generator circuit has an input coupled to the output voltage node of the charge-pump circuit; and
the clock generator circuit controls the first and second clock phases based on the voltage level at the output voltage node exceeding or falling below a predetermined threshold.

9. The charge-pump circuit of claim 1 wherein the charge-pump circuit is a step-up charge pump circuit which achieves a regulated output voltage with a wide range of effective step-up conversion ratios and provides improvements in efficiency using a four switch, one flying capacitor, doubler switch topology and an auxiliary voltage input.

10. A charge-pump circuit comprising:
a capacitor having first and second capacitor terminals;
a first switch coupled between the first capacitor terminal and an output voltage node;
a second switch coupled between the second capacitor terminal and an auxiliary supply voltage input node;
a third switch coupled between the first capacitor terminal and a primary supply voltage input node; and
a fourth switch coupled between the second capacitor terminal and the output voltage node.

11. The charge-pump circuit of claim 10 wherein:
the first and second switches operate in synchronization with each other; and
the third and fourth switches operate in synchronization with each other,

12. The charge-pump circuit of claim 10 wherein the auxiliary supply voltage input node has a configuration that receives an auxiliary supply voltage input different from the primary supply voltage input at the primary supply voltage input node.

13. The charge-pump circuit of claim 12 wherein the charge-pump circuit outputs at the output voltage node a step-down version of the voltage at the primary supply input node based on the voltage at the auxiliary supply input node.

14. The charge-pump circuit of claim 10 wherein:
the first and second switches are closed during a first clock phase and open during a second clock phase;
the third and fourth switches are open during the first clock phase and closed during the second clock phase; and
the first and second clock phases are complementary clock phases.

15. The charge-pump circuit of claim 14, further comprising a feedback regulator controlling the first and second clock phases based on a voltage level at the output voltage node.

16. The charge-pump circuit of claim 15 wherein the feedback regulator comprises a clock generator circuit outputting a first clock signal for controlling the first and second switches and a second clock signal for controlling the third and fourth switches, wherein the clock generator circuit controls first and second clock phases of the first and second clock signals based on the voltage level at the output voltage node.

17. The charge-pump circuit of claim 16 wherein:
the clock generator circuit has an input coupled to the output voltage node of the charge-pump circuit; and
the clock generator circuit controls the first and second clock phases based on the voltage level at the output voltage node exceeding or falling below a predetermined threshold.

18. The charge-pump circuit of claim 10 wherein the charge-pump circuit is a step-down charge pump circuit which achieves a regulated output with a wide range of effective step-down conversion ratios and provides improvements in efficiency using a four switch, one flying capacitor, halfer switch topology and an auxiliary voltage input.

19. A method of operating a charge-pump circuit including a charge-pump capacitor, the method comprising:
during a first clock phase, coupling the capacitor of the charge-pump circuit to an auxiliary voltage supply input; and
during a second clock phase distinct from the first clock phase, coupling the charge-pump capacitor in series between a primary voltage supply input node and an output node of the charge-pump circuit,
wherein the auxiliary voltage supply receives a supply voltage different from a voltage level at the auxiliary voltage supply input node of the charge-pump circuit.

20. The method of claim 19 wherein during the first clock phase, the coupling comprises coupling the capacitor in series between the auxiliary voltage supply and a ground node.

21. The method of claim 19 wherein, during the first clock phase, the coupling comprises coupling the capacitor in series between the auxiliary voltage supply and the output voltage node.

22. The method of claim 19, further comprising regulating the first and second clock phases based on a comparison between the voltage level at the output voltage node of the charge-pump circuit and a reference voltage level.
